(19) United States
(12) Patent Application Publication
(10) Pub. No.: US 2008/0114738 A1
(43) Pub. Date: May 15, 2008

(54) SYSTEM FOR IMPROVING DOCUMENT INTERLINKING VIA LINGUISTIC ANALYSIS AND SEARCHING

(76) Inventor: Gerald Chao, Los Angeles, CA (US)

Correspondence Address: LEWIS, BRISBOIS, BISGAARD & SMITH LLP, 221 NORTH FIGUEROA STREET, SUITE 1200, LOS ANGELES, CA, 90012, US

(21) Appl. No.: 11/939,430

(22) Filed: Nov. 13, 2007

Related U.S. Application Data
(60) Provisional application No. 60/865,448, filed on Nov. 13, 2006.

(51) Int. Cl. G06F 17/30; G06F 7/00

(52) U.S. Cl. 707/3; 707/102; 707/E17.014; 707/E17.049

(57) ABSTRACT

A method for dynamically interlinking documents within a collection, comprising downloading documents within said collection; generating a reverse index and a content signature database of said collection, selecting for each document within said collection, a list of words within to convert into search links, based on the said content signature database, and displaying search results based on said reverse index.

This application claims priority from U.S. Provisional patent application 60/865,448, filed Nov. 13, 2006, which is incorporated herein in its entirety.

### BACKGROUND OF THE INVENTION

In the information revolution currently underway, the most common way for interlinking digitized information is via hypertext links, which are one of the most fundamental parts of the World Wide Web. Authors inter-relate documents and information by inserting connections between them for their readers, so that they can also make similar connections. By weaving a web of how information is connected to one another, this effective form of encoding knowledge is what makes the World Wide Web so universally useful.

However, while hypertext links are invaluable in capturing the connections between existing information, they are not designed for keeping up with new content. That is, when a hyperlink is inserted by its author, it is a static reference to some information available at that point in time. While some information may be time invariant, such as definitions and historical facts, most is dynamic, constantly being updated and retold. Having the ability to not only connect relevant information at the present, but also new content going forward, would alleviate the problem of links becoming obsolete as soon as they are published.

However, currently there are no good solutions to this problem. That is, once some information is published, its hypertext links are rarely updated, due to the laborious and exponential efforts needed to update the links so that they point to the latest resources. Links are thus allowed to languish and become irrelevant with time.

Because of this staleness factor, for the readers the most common reaction is for them to go to a search engine, enter some search term, and “manually” find the latest information on a particular topic. Such action is not beneficial, and often detrimental to the publisher, since their audience would leave their site to find related content as dictated by the search engines, not them.

An alternative is to automatically insert hypertext links into content, which link to search results, based on set of keywords or topics of the publisher's choosing. This is usually done by matching the content of a page against a static list of keywords, like a dictionary or ontology. While this solution addresses the freshness and reader defection issue, this simple solution will lose its effectiveness as the readers see the same links repeatedly, causing “link fatigue” where they stop visiting the links because of repeat exposures.

Therefore, the need exists for an automated system of identifying and inserting hypertext links to inter-relate content dynamically, such that the most up-to-date and relevant information is made available for the readers. This would free the content creators from the laborious task of managing and manually inter-linking their content for every addition or edit, thus allowing them to stay focused on content creation.

This process of selecting which topics to interlink must be dynamic and relevant to the central topic of the content to be effective. To fully engage the readers, the links chosen should reflect the central theme of the content, otherwise they would appear as distractions, and since content at a site is usually constantly changing, a static list would become outdated over time. While one can maintain such a list manually, this is a difficult task even for small sites, and untenable for large sites with high volumes of new content or user-generated content such as discussion forums.

Additionally, automatic ranking and filtering of the topics is needed to choose the most relevant topics users would find most useful, instead of linking every term. Otherwise readers would be overburdened with useless links that they will avoid all-together. The analogy is a search engine ranking system, only presenting the ten most relevant results, instead of showing 200, or so, and letting the reader sort through to find the ones relevant to them.

Lastly, the automatically inserted links should be sensitive to linguistic constructs to maximize relevancy. For example, the automated system should recognize that “stem cell research” is an unique topic to inter-link, not as independent keywords “stem”, “cell” and “research”, which are quite different semantically and thus would be far less relevant.

### SUMMARY OF THE INVENTION

The present invention is a method and system for automatically identifying and inserting links to interconnect content within a collection, and for each link, the present invention provides the most up-to-date and relevant content from that collection.

This system, called Dynamic Search-link Insertion (DSI), enables a collection of content to be automatically interlinked and dynamically updated as new content is added to and modified within the collection. Integral to this system is giving the publisher control over what goes into the collection, allowing them to dictate what content to interconnect, not a 3^{rd} party like search engines.

To effectively determine what concepts to automatically insert as links, the DSI system first processes the entire collection to generate a reverse index, which is used for searching the collection. During the index building process, an account of the concepts contained in the collections, called “content signature”, is derived. This enables the DSI system to insert only links for concepts that the collection has more content for.

Once the content signature is compiled, DSI's link selection algorithm goes through each document within a collection to rank and select the links most relevant to that document and collection. As new documents are added and existing ones updated, they are indexed and updated in the same way.

The result of the link selection algorithm is a list of keywords and phrases to be converted to links for a page. This data can then be presented to the readers of that page a variety of ways, such as inserting hypertext links where the keywords and phrases appear, or displaying them on dedicated areas on the page. Associated with each keyword or phrase are links to related documents from the same collection, generated via searching the reverse index, built and updated during the indexing phase, completing the process of dynamically interlinking the content. And because the search index is constantly being updated, these links to related documents are always up-to-date.

To allow the content creators editorial control over these links, they are given the ability to specify which concepts to always or never be converted into search links. Additionally, they have manual override as to where the dynamic links appear and what the search terms should be. This provides them the fine-grained control over the link placements, but still benefit from the live search results to maintain the freshness of the links.

### BRIEF DESCRIPTION OF THE FIGURES

FIG. 1 is an block diagram of the Dynamic Search-link Insertion system described in the present invention.

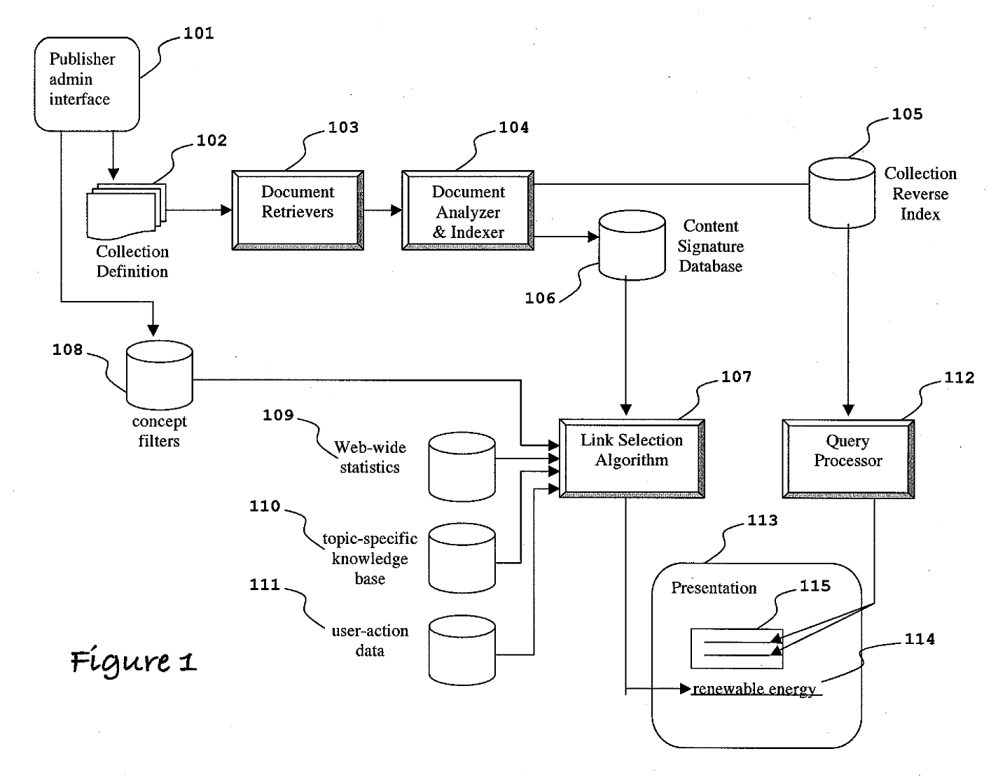

FIG. 2 is a flow chart of the link selection algorithm within the DSI system.

FIG. 3 is an example embodiment of the present invention, depicting how related articles are recommended for the automatically inserted link of “Advanced Micro Devices.”

### DETAILED DESCRIPTION OF THE PREFERRED EMBODIMENTS

The present invention is a method and system to dynamically interlink content within a collection, such as within a website, within a set of newspapers, across the World Wide Web, etc, by automatically inserting links to connect related content within the collection. This is an improvement over the existing hypertext links, which are static pointers to content that can quickly become out-of-date, something remedied only by manual editing. With the present invention, links are automatically identified and refreshed to reflect changes in the collection, reducing the burden on the content creators to maintain the links.

The process begins with the definition of a collection 102, for example a single website, a collection of blogs, or Web documents about health. These definitions can be defined as simply a list of URLs, a set of keywords, or a list of categories, via the Publisher administrative interface 101.

For each collection, Document Retrievers, or crawlers, 103 then downloads the content into the system for analysis. A crawler is an automated program that downloads documents based on a list of URLs, in this system as specified by the collection definition. The documents are then sent to the lexical analyzer and indexer 104, which first extract textual data from the documents and then create an inverted index 105 for searching.

Optionally, the lexical analyzer can encompass a natural language processor, which performs tasks such as part-of-speech tagging, phrase identification, and full sentential parsing. This improves the quality of the links as described earlier, by resolving language ambiguities to improve accuracy and quality. This enables the indexer and link selection algorithm to improve relevancy based on the added information (e.g., “computing is a noun”) and improve quality by operating only on linguistically coherent units (e.g., stem cell research).

The output of this phase is the reverse index and the collection-specific Content Signature database 106. This is then fed to the link selection algorithm 107, which is described in more detail in the next figure. The reverse index is used for searching of related articles, such that given a concept like “renewable energy” or “patent office”, articles related to that concept are retrieved from the reverse index. This reverse index is updated by the indexer as content within the collection is updated, enabling the DSI system to recommend the most recent and relevant content.

For each collection, the Content Signature database consists of a list of concepts and for each concept its weight of importance within the collection. This weight consists of a mixture of factors, including the number of times it appears within the collection, the ratio between its occurrence within the collection to a larger collection like the entire Web 109, the semantic distance to other concepts within the same collection, or even a specialized lexicon or ontology 110 for that collection, such as medical terms. Put simply, for each concept, the Content Signature database stores a measure of importance to that collection, so “Tiger Woods” may be important to a sports collection, even more important to a golf collection, but not very much to a collection on archeology, for example.

This weight is computed as the probability of a topic T becoming a link conditioned on a collection, i.e., P(T|collection). That is, given a particular collection, what is the probability that a topic T be converted into a link. The higher the probability, the more relevant the topic is to that collection and thus more likely to be chosen to become a link. This is in comparison to the prior probability P(T), i.e., not conditioned on any collections and is derived from all the collections combined.

This conditional probability distribution can be estimated using the mixture of factors described earlier, and improved upon by using statistical algorithms to train parameters using user actions 111 as training data. That is, using the conditional distribution of the topics users clicked on (K) within a collection, P(K|collection), as the target distribution, statistical learning algorithms, such as maximum entropy and support vector machines, can be used to train the parameters to improve the estimation of P(T|collection). This requires enough user action data to make P(K|collection) reliable, but once that's the case, the two distributions will become a positive feedback loop that maximizes the relevancy of the links chosen in the collection. That is, as more data is collected from what users actually clicked on, it will improve the automatic link selection algorithm, which in turn will generate more user clicks since they are more relevant.

Independent of the user action data for any collection, the DSI system needs to select high-quality links so users will click on them to bootstrap the feedback loops. This is accomplished by relying on the prior distribution P(T), which estimates the importance of topic T across all collections. For this estimation any large collection can be used, including documents on the World Wide Web, arguably today's largest publicly accessible collection. The larger the collection, the more reliable the estimation of P(T) becomes.

The estimation of P(T) includes a mixture of factors, including the number of time it appears within the collection, the number of documents it appears in, the ratio of documents containing the topic to those without, the number of times it appears in the title of documents, the number of times it is used as anchor text (the text within a HTML anchor tag), and the number of times it is searched for at search engines. What this distribution captures is the information value of T, in that, what is the likelihood that a human reader would like to find out more about the topic T.

Similar to the conditional distribution P(T|collection), the estimation of P(T) can be improved by training upon user-action data. Such data can be the aggregated clicks of the DSI links from across the collections, or clicks on existing hypertext links collected using a browser toolbar or other client-side click monitoring tools (such as opt-in Javascript applets). This data can then be used to estimate P(K), the prior distribution of topics humans actually clicked on. Statistical training algorithms can then be used to train parameters of P(T) to best match the P(K) distribution.

The resulting distribution P(T) can then be used by the Link Selection algorithm for content that's not part of a particular collection, or when statistics on a small or nascent collection are not yet reliable. This prior distribution of P(T) acts as an important basis for link selection so that links of high relevancy are chosen by default, and improved by the conditional probability as more statistics are gathered for each collection.

These two distributions play an important role, but not the only role, for selecting topics to become links. The overall task is done by the Link Selection algorithm, which takes as input a list of topics from a page, and as its output a list of topics that are to become links, that are ranked by its order of relevancy, which is described in more detail in the next section.

Once the links are chosen for a page, the last component of the DSI system is the user-facing services, where the search links are added to pages so that the end users can utilize them to access related content. This can be done in batch-mode, where a collection is downloaded and processed at once, or dynamically analyzed as pages are viewed by the readers. The batch-mode is useful for static collections, whereas the dynamic mode is useful for fast changing content such as news or user-generated content, such as discussion forums and comments. However, in most situations a mixture of the two is used, where a collection is seeded with a set of documents to compute its content signature, and as new documents are added and modified, they are dynamically analyzed and added to the collection.

As for presentation, there are multiple methods to present the dynamic search links to the end-users 113, but the exact method is not central to the present invention as long as users are able to see and click on links to access the related content retrieved by the DSI service. One possibility is to alter the original documents and insert hypertext links to generate an augmented version of the documents. Another possibility is to add them using client-side scripting such as Javascript or ActiveX. Server-side inclusion is also possible but would require more integration work, especially compared to client-side scripting, which would only require simple modifications to the original documents.

When end-users click on these inserted search links 114, they will be presented with a list of search results of the highlighted concept, providing them with the most recent content that's most related to that concept. Therefore, as new content is added about this topic, they are automatically retrieved via this search process.

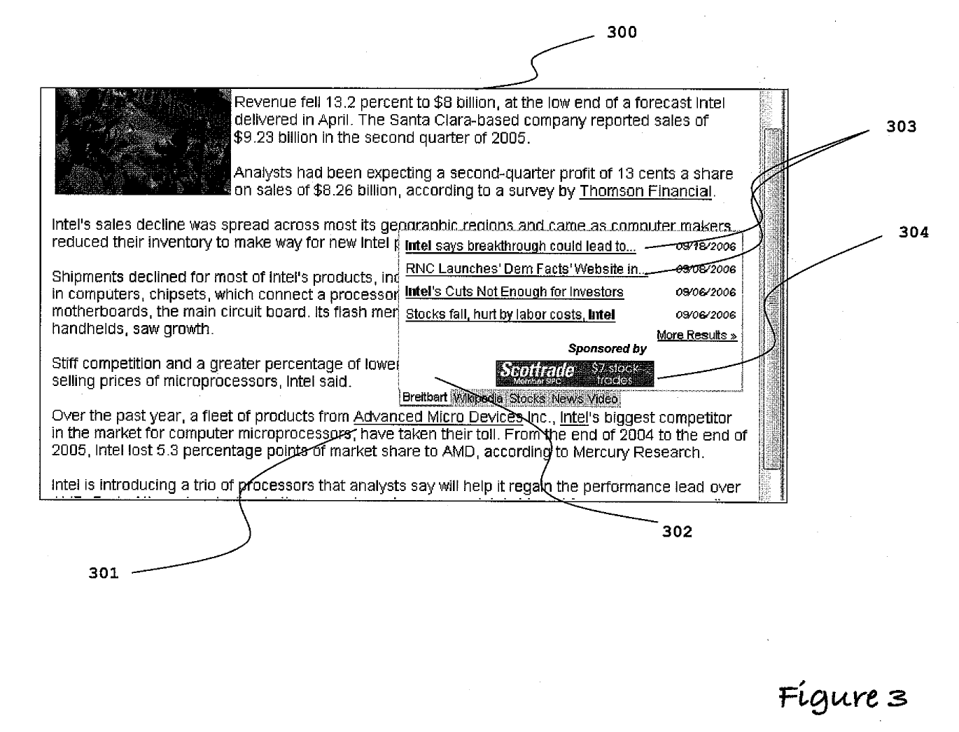

In addition to the search links, an enhancement is to present the search results directly within a small window that appears when users visit a highlighted concept 115, an example shown in FIG. 3. In doing so, users can more easily see the related content, without leaving their place within the current document. The more engaged the readers are, the longer they tend to stay on the site. Additionally, these windows provide the opportunity for a site to inform their users of the site's other content without having to inundate them with more links.

Lastly, because these windows provide useful information and resources, users find it worthwhile to use them, especially with topics they find interesting or would like to find out more about. Once users experience and understand the usefulness of the windows, they are more willing to accept advertisements within that space. That is, a website can add advertisement, like a sponsorship, to the side or bottom of the window to generate additional revenue, and their users will continue to visit the search links and not object to the ads because the content within the window remains useful to them. This is as opposed to a popup ad where the sole content of the window is advertisement, which is of minimal information value to the end users and thus would be avoided in the future.

Furthermore, the advertisement or sponsorship placed in the floating window can be highly targeted towards the concept the user visited. This active expression of interest in a particular concept is what makes the targeting effective. For example, when a user visits a “golf clubs” or “plasma TVs” link, the advertisement can be about those topics, in the event that an user wishes to purchase the item. Concepts of little interest to users, “lawn mowers” for example, will not be visited. Therefore, advertisers would only show their ads to readers interested in a particular concept, hence the better targeting. Nevertheless, during the rest of the instances when they are not interested in buying the product, the window will consistently present them with informative content for their enjoyment.

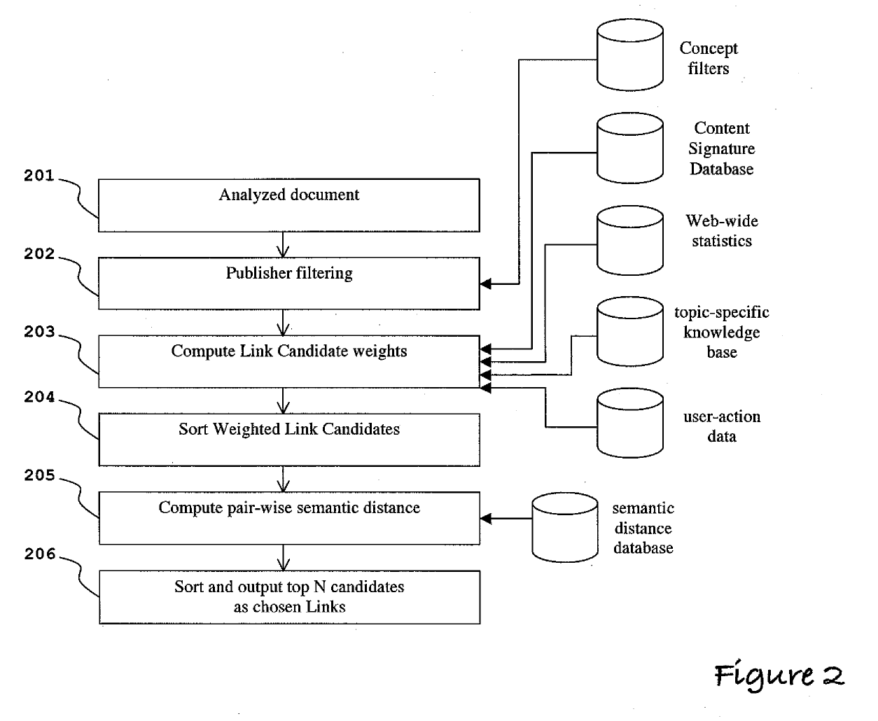

FIG. 2 is a flowchart of the DSI system's Link Selection algorithm. The input 201 can simply be a list of keywords from a document, or output from lexical analyzers, or in-depth natural language analyzers. The more in-depth analyzers provide more precise decomposition of the input document, such as identifying the noun phrases, word senses, and anaphora resolution. The more precise the input document is analyzed and ambiguities resolved, the more reliable the input into the algorithm becomes. For example, identifying that “stem cell research” is a noun phrase and thus should not be treated as individual keywords of “stem”, “cell” or “research.” The items in this list are referred to as candidates, each containing at the minimum, the words, plus additional features, such as whether it is a noun phrase and the subject of the sentence.

The candidates are first checked against a list, if any, of concepts the administrators of the collection do not wish to become search links, such as “home page” and “site search.” This step, called Publisher filtering 202, provides a mechanism for editorial control over the inserted links.

The next step 203 calculates the probability of each candidate becoming a link L given the current document D, or P(L|D), where D is represented by the list of candidates within the document. Instead of computing this probability directly, Bayesian inversion formula is used to transform the probability into:

P(L|D)=P(D|L)×P(L)/P(D)

With this inversion, observations from training data can be used to compute P(L), and since P(D) is the same across all candidates within D, the term can simply be ignored. That is, to compute P(L), we can either use the P(T) distribution as described before, or if the document is within a collection, P(T|collection).

The term P(D|L) is the joint probability of all candidates within the document D given L, which is difficult to estimate because of data sparseness. That is, it is difficult to estimate the likelihood of all words within the document D given one of its words. Therefore, take the independent assumption between the words within the documents and estimate this term as:

P(D|L)˜=Π P(C|L), where C is a candidate within D.

That is, compute P(D|L) as the pairwise probabilities between L and each candidate C in D to appear in the same document, such as P(“tiger woods”|“golf”), which is much easier to estimate from data. These pairwise probabilities 205 can be estimated based on each collection or statistics collected from Web-wide documents.

Once the term P(L|D) is computed for each candidate L, the last step 206 is simply to sort by this value and return the top N candidates. One can see that most of the work in the module is the lookup of parameters computed previously, an important factor in real-world environment where speed and minimal delay is a priority.

FIG. 3 shows an example embodiment of the presentation of the Dynamic Search-links that was inserted into a news article 300. In this embodiment the dynamically inserted links are shown as single black underlines, such as “Advanced Micro Devices” 301 and “Intel.” When users move their mouse cursor over these links, a floating window 302 appears that contains live searches of the most recent and relevant links 303 about that topic. This floating window showcases the additional content from the publisher, while providing the readers with very convenient access to related content. This newly-created real-estate can also be used for sponsorships 304 as a way to generate additional revenue for the site.

I claim:

1. A method for dynamically interlinking documents within a collection, comprising:
downloading documents within said collection;
generating a reverse index and a content signature database of said collection,
ranking and selecting for each document within said collection, a list of words within to convert into search links, based on said content signature database, and,
displaying search results relevant to the selected words based on said reverse index when users click on said search links.

2. The method of claim 1 wherein said collection is defined by at least one of universal record locators (URLs), a set of keywords or a list of categories.

3. The method of claim 1 wherein generating a reverse index comprises at least one of part-of-speech tagging, phrase identification, name entity recognition or full sentential parsing of said documents.

4. The method of claim 1 wherein generating said content signature database includes:
determining a list of concepts related to content of said collection; and,
for each said concept determining a factor-based value for its weight of importance within said collection.

5. The method of claim 4 wherein its factor-based value is the probability of a topic T being converted into a link for said collection from a mixture of factors including:
the ratio between the occurrence of said concept within the collection and the occurrence in a larger collection;
the pair-wise co-occurrence statistics between concepts within said collection and across a larger collection;
the semantic distance to other concepts within said collection;
the semantic distance to other concepts within a predetermined lexicon or a predetermined ontology for said collection.

6. The method of claim 4 further including:
using statistical algorithms based on user actions to improve said factor-based weight value; and,
for each said concept determining a statistical algorithm-based value for its weight of importance within said collection.

7. The method of claim 6 wherein the statistical algorithm-based value is the probability of a topic K becoming a link conditioned on the number of user clicks for that topic in said collection.

8. The method of claim 7 further comprising:
providing a positive feedback loop that adjusts the factor-based value for each concept and the statistical algorithm-based value for each concept, to maximize the probability for clicks.

9. The method of claim 8 further comprising computing said factor-based values across multiple collections from a mixture comprising the number of times each concept occurs across said collection, the number of times each concept occurs in titles of documents, the number of times each concept occurs within anchor text and the number of times the concept was the subject of a search querie.

10. The method of claim 1 wherein displaying the search results is dynamic display.

11. The method of claim 1 wherein displaying the search results is by a combination of batch display and dynamic display.

12. The method of claim 1 wherein the displaying includes:
presenting said search results directly within a small window.

13. The method of claim 10 wherein said search results include a plurality of highlighted concepts for each document within the collection, and said search results are presented when a user visits a highlighted concept.

14. The method of claim 12 further providing advertisement within said window, targeted towards the concept being visited by the user.

15. A method for automatically inserting links to interconnect content within a collection of documents comprising generating a reverse index of concepts within said collection of documents, selecting the concepts within the reverse index which are the most relevant to the collection of documents, creating a list of keywords and phrases from the most relevant concepts, creating links in said collection of documents to other documents containing said keywords and phrases and automatically updating the reverse index as content is added to the collection of documents.

16. The method of claim 15 further comprising using natural language analysis to generate said reverse index.

17. The method of claim 15 further comprising inserting hypertext links where the keywords and phrases appear.

18. The method of claim 15 further comprising linking each keyword and phrase to related documents from the same collection.

19. The method of claim 15 further comprising pre-selecting which concepts are always connected to search links and which concepts are never converted to search links.

20. The method of claim 15 in which a concept to be selected is determined by the frequency of its occurrence, the ratio of its occurrence within the collection as compared to a larger collection, the semantic distance to other concepts within the same collection or by use of a lexicon for the collection.
